(19) United States
(12) Patent Application Publication
(10) Pub. No.: US 2010/0198854 A1
(43) Pub. Date: Aug. 5, 2010

(54) SYSTEM AND METHOD FOR SEARCHING MULTIPLE CONTACT INFORMATION SOURCES IN A NETWORK-BASED ADDRESS BOOK SYSTEM

(75) Inventors: Suresh Chitturi, Irving, TX (US); Jan Hendrik Lucas Bakker, Irving, TX (US)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(73) Assignee: RESEARCH IN MOTION LIMITED, Waterloo (CA)

(21) Appl. No.: 12/698,680

(22) Filed: Feb. 2, 2010

Related U.S. Application Data
(60) Provisional application No. 61/150,208, filed on Feb. 5, 2009.

(51) Int. Cl. G06F 17/30; G06F 7/00

(52) U.S. Cl. 707/760; 707/802; 707/E17.032; 707/E17.13; 707/E17.044; 715/739

(57) ABSTRACT

Methods are provided for searching at least one directory that is external to an address book architecture including a client and a server. In one embodiment a client may communicate a contact search request that specifies an external directory which does not support a standard search format, the request causing the server to translate the request to an external search request in another format supported by the external directory. In another embodiment a server may translate a contact search request received from a client when the request specifies an external directory which does not support a standard search format. In yet another embodiment an interworking function, which is operable to import contact information from a legacy address book storage to a converged address book storage, of an address book server is adapted to query an external directory which does not support a standard search format.

### CROSS-REFERENCE TO RELATED PATENT APPLICATIONS

This patent application claims the benefit of U.S. Provisional Patent Application No. 61/150,208 filed Feb. 5, 2009.

### TECHNICAL FIELD

The present disclosure relates generally to communications devices, systems and methods employing a converged address book. More particularly, the present disclosure relates to searching multiple contact information sources in a converged address book system.

### BACKGROUND

Electronic address book applications that execute on electronic devices (e.g., smartphones, PDAs, portable computers, etc.) are useful for establishing and maintaining relationships between people. A typical address book application is configured to access contact entries that are stored locally on the device executing the address book application or remotely (e.g., on a server, database or other network element). Each contact entry includes contact information such as, for example, a name, physical address, email address, telephone number, personal identification number, instant messaging identifier, among others. Accordingly, the contact entries enable a user of the device to contact or otherwise communicate with other individuals associated with the contact entries.

Growing innovation across services domain and mobile devices creates a number of ways to organize and manage contact information. Additionally, many different types of contact management/address book applications, associated data formats and protocols to manage the contact information and entries exist. While device users enjoy a variety of choices vis-a-vis contact management, the presently available options cause interoperability issues across differing address book applications and contact information sources. In other words, there is a lack of unified and consistent user experience across devices with regard to address book applications, particularly for wireless mobile devices where device users expect ease of use and personal computer (PC) type functionality.

Several activities are under way by standards organizations such as the Open Mobile Alliance (OMA) Converged Address Book (CAB), Open Mobile Terminal Platform (OMTP) and Internet Engineering Task Force (IETF) to improve interoperability and user experience by providing a common address book system. With regard to OMA CAB (also referred to hereinafter as the CAB Enabler), Contact Search is one functionality as follows:

The CAB Enabler aims to provide a mechanism to search for Contact information or Contract entries. Users of the CAB Enabler are able to search for the contact information from within the host CAB system, remote CAB system and/or external sources(s) made available by the service provider (e.g., Yellow Pages™, 411 directory assistance, etc.). The contact information made available for search operation may be subject to CAB user's authorization rules (e.g., contact information being limited by a user-defined contact view based on subscription) and service provider's policy.

One proposed way of providing contact search functionality uses a simple HTTP interface between the device and the network-based system (such as CAB) which is responsible for carrying the CAB User's search request towards the Network-based Address Book (NAB) system. Using a simple HTTP interface provides a keyword search in a generic fashion. Furthermore, the HTTP interface also provides a mechanism to embed an XQuery into the search request.

Although proposed solutions including the foregoing-mentioned HTTP interface facilitate contact search functionality, a new converged address book functionality for searching multiple external contact information sources (e.g. including non-XCAP/XDM based data sources) and, optionally aggregating the search results from the multiple sources would be a useful development in the art.

### BRIEF DESCRIPTION OF THE DRAWINGS

FIG. 1 is a block diagram illustrating a conventional address book system;

FIG. 2 is block diagram of example functional modules for the address book server shown in FIG. 1;

FIG. 3 is a block diagram illustrating another conventional address book system;

FIG. 4 shows an example diagram for searching multiple external contact information sources;

FIG. 5 shows an example diagram for searching XDM-type and non-XDM-type contact information sources;

FIG. 6 is a flow diagram illustrating an example method of searching multiple contact information sources;

FIG. 7 is a flow diagram illustrating another example method of searching multiple contact information sources; and

FIG. 8 illustrates an example mapping of data between an external data source and a standard XML data format that may be searched against.

### DETAILED DESCRIPTION

The present disclosure provides a method and system for searching multiple contact information sources in a network-based address book (NAB) system (e.g., an architecture defined by OMA CAB). More particularly, the present disclosure provides systems and methods for enabling users to search external sources (e.g. non-XDM type sources for contact entries and/or contact information), in addition to XML data management (XDM) type sources (e.g., a personal contact card (PCC) XDM server, an address book XDM server, and the like) as well as. Although the system is referred to herein as a “network-based” address book system, one or more devices, which are employed by users of the system, may also include contact entries and/or contact information stored locally. That is, devices may include contact entries and/or contact information in fixed or removable memory, e.g. SIM card, SD card, flash memory, etc. Turning now to the Figures, example systems and methods are described.

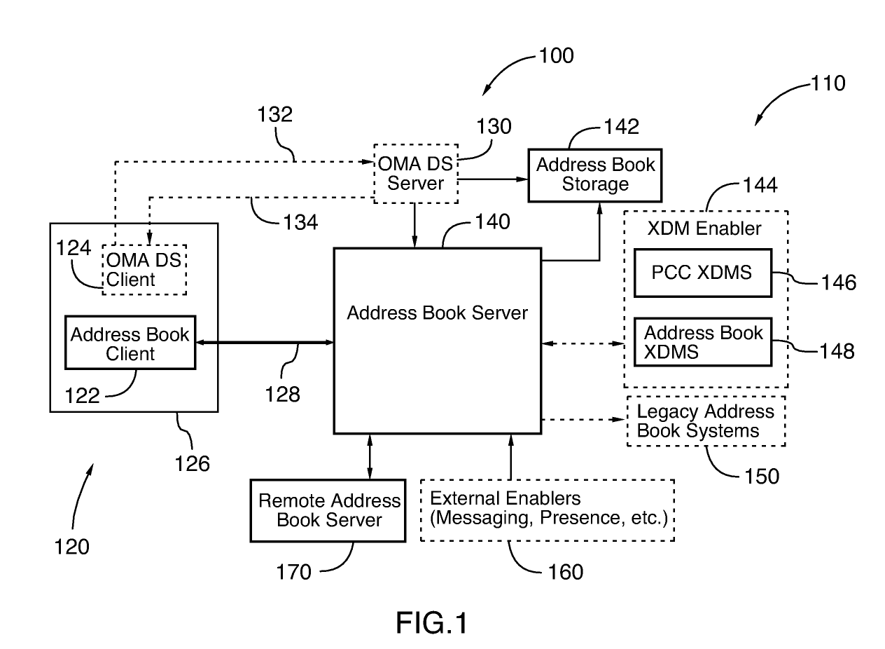

FIG. 1 shows an example address book system 100. As shown, the system 100 is configured with a network side 110 and a device side 120. Both of the network side 110 and the device side 120 may include one or more entities, components or modules as shown which may be implemented as hardware, software or a combination of hardware and software. Device side 120 could be at least partially configured on any suitable device 126 on which a common address book might be used. Example devices include wireless communication devices such as cell phones, personal digital assistants, two-way pagers, smartphones, portable computers or other such devices that include a processing module (e.g., microprocessor, CPU, etc.), a storage module (e.g., RAM, ROM or other memory) and a communication module (e.g., radio transceiver, etc.). Device side 120 could be at least partially configured on wired devices such as personal computers, laptop computers, set-top boxes among others. Although not shown in FIG. 1, one or more of the device side components (e.g., the address book client 122) may alternatively be implemented as part of the network side 110.

Device side 120 includes an Address Book (e.g., CAB) client 122. Address Book client 122 communicates with the Address Book Server 140, which will be described hereinafter. The interface 128 linking the address book client 122 and the address book server 140 carries communications such as notify, subscribe, search, share, and import, among others, between the network side 110 and the device side 120.

The underlying protocol for the interface 128 between address book client 122 and address book server 140 may be implemented using HyperText Transfer Protocol (HTTP). Furthermore, the body or the payload of the protocol may contain the necessary syntax to convey the requests. However, the communications carried on interface 128 may be of various formats and protocols including SIP type messages.

A further functional block on device side 120 is the Open Mobile Alliance (OMA) Data Synchronization (DS) Client 124. The OMA DS Client 124 may be configured to cooperate with the address book client 122 for synchronizing a user's personal contact information and address book data between the device side 120 and the network side 100. That is, the OMA DS Client 124 may facilitate OMA CAB functionality known as Contact Synchronization. Contact Synchronization functionality may be implemented using an OMA Data Synchronization (DS) server 130 which is configured to communicate or otherwise cooperate with OMA DS Client 124 via OMA DS-1 interface 132 and OMA DS-2 interface 134.

In one embodiment the underlying protocol used for synchronization can be HTTP or Wireless Application Protocol (WAP) PUSH. The notification message framework defined by OMA DS may be used as a mechanism for the notification of CAB information to the CAB user (the CAB user being an individual employing the device 126 with client 122). For example, updates to contact information resulting from contact subscriptions, changes in a user's personal contact card information, CAB status, among others, may be used in the notification. Notifications may also be delivered through other mechanisms such as Short Message Service (SMS), Multimedia Message Service (MMS), email, instant messaging, SIP Subscribe/Notify (e.g., per IETF RFC 3265), SIP PUSH (e.g., per OMA “Push Architecture,” OMA-AD-Push-V2.2), among others.

As further shown in FIG. 1, the network side 110 of system 100 further includes address book storage 142, XDM enabler 144 (e.g., as specified by the OMA XDM specification) as well as ancillary architecture which may interface with the address book server 140. The ancillary architecture may include legacy address book system(s) 150, external enabler(s) 160 (e.g., client-server type architectures defined by OMA for messaging, presence, etc.) and remote address book server(s) 170 as shown. Local address book storage may exist (e.g., on device side 120 as a database or other data structure in a memory of the device 126). Such local address book storages may include copies of contact entries or contact information stored in the network side 110. The locally-stored contacts may be synchronized with network-stored contacts. Furthermore, local address book storage may include one or more legacy, proprietary or standards-based local address books, and the like. In addition, one or more corporate (e.g., enterprise-based) address books may be stored in the local address book storage. It may be that one or more corporate address books cannot be accessed and searched from network side 110, for example, due to lack of credentials.

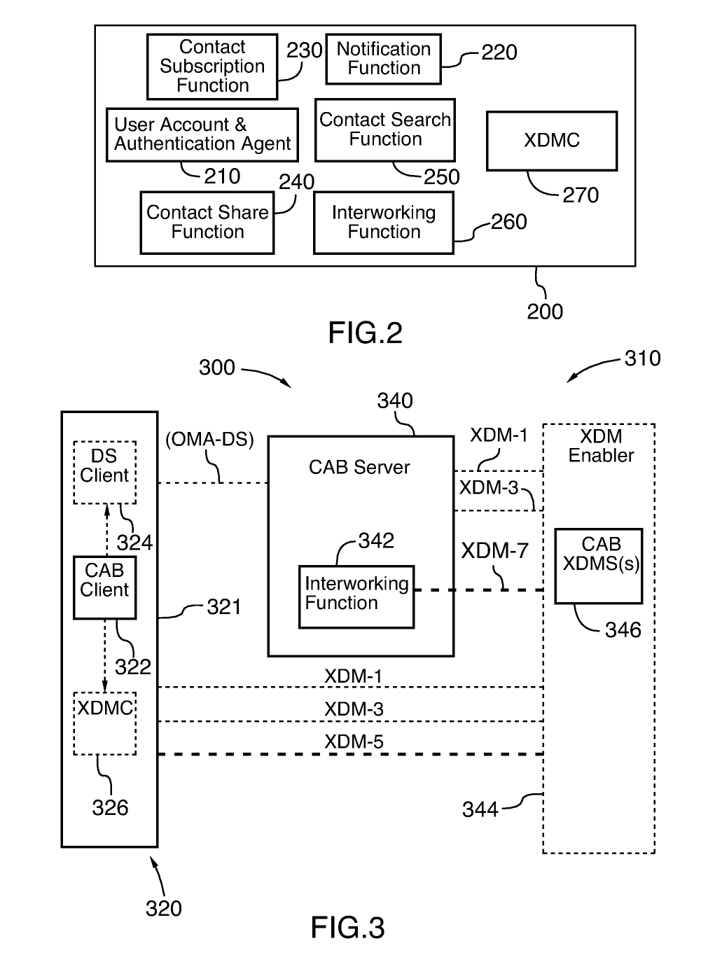

Referring to FIG. 2, an address book server 200, which may be similar to or different than the address book server 140 of FIG. 1, may include one or more modules to provide the address book system 100 with OMA CAB-defined functionalities including Contact Search, Contact Share, Contact Subscription, and the like. Address book server 200 may be a hardware device (e.g., server computer) with a processing module that executes address book server software, firmware or instructions to provide the foregoing-mentioned functionalities. Although modules 210-270 are shown in FIG. 2 to be configured as part of the address book server 200, one or more modules 210-270 may be configured elsewhere in the system 100. Modules 210-270 will now be described in detail.

User account manager and authentication agent module 210: this module is responsible for managing user authentication and account information including user preferences and custom aspects, such as configuration to synchronize only partial address book data from the server to the client (e.g., client 122), receive/not receive notifications, among others.

A notification function module 220: this module is used to notify the client (e.g., client 122) of updates in a subscribed contact. This function may use the DS notification framework or other mechanisms such as email, SMS, Instant Messaging (IM), SIP Subscribe/Notify, among others.

XML Document Management Client (XDMC) module 270: this module is responsible for cooperating with an XML Document Management Server (XDMS) module for management (e.g., accessing and processing) of address book data. This address book data could be information stored in or associated with a personal contact card (PCC) XDM server (e.g., block 146 of FIG. 1) as well as information stored in or associated with an address book XDM server (e.g., block 148 of FIG. 1). To this end, the XDMC module 270 may communicate or otherwise cooperate with the Contact Search Function module 250 or Interworking module 260.

As further shown in FIG. 2, the address book server 200 is configured with Contact Subscription Function module 230, Contact Share Function module 240, and Interworking Function module 260 to perform CAB-related functionality including contact subscription, contact share and communication with legacy address books respectively.

Referring again to FIG. 1, the network side 110 further includes the XML Document Management (XDM) Enabler 144. The XDM Enabler 144 includes a personal contact card (PCC) XML Document Management Server (XDMS) 146, which may include PCCs for the system 100. Furthermore, the XDM Enabler 144 includes an Address Book XDMS 148, which may include contact entries or links/references to contact entries for the system 100.

The Address Book Storage 142 shown in FIG. 1 may be configured as a server or database that stores an address book for each user on the network. This storage 160 can be accessed, modified, synchronized, etc. with an address book client 122 on the device.

A further component on the network side 110 may be remote address book server(s) 170 since additional address book servers may be hosted in other network domains or by other network operators. The remote address book server interface may permit interworking between trusted address book systems in one or more network domains.

A further component on network side 110 may be network based legacy address book systems 150. Legacy address book systems are address book systems that may already exist. For example, Facebook™, Outlook™, Yahoo!™ contacts, among others, may already exist on the network side. These legacy systems are used to manage personal contact and address book information and are network based.

Turning now to FIG. 3, another example address book system 300 is provided. As shown, the system 300 is configured with a network side 310 and a device side 320. Device side 320 could be at least partially configured on any suitable device 321 on which a common address book might be used. Example devices include wireless communication devices such as cell phones, personal digital assistants, two-way pagers, smartphones, portable computers or other such devices. Device side 320 could be at least partially configured on wired devices such as personal computers, laptop computers, among others. Alternatively, one or more of the device side components (e.g., CAB client 322) may be implemented as part of the network side 310. If the device side components are implemented as part of an address book system client in the network, the system may be configured with an interface between the device and the device side components. In an implementation where the client is configured in the network, channels employing one or more protocols defining such an interface between the device and a network-based client can be optimized to reduce the verbosity of requests as well as the overhead associated with certain protocols such as SIP Subscribe/Notify. Such optimizations may improve battery life of the device. If a choice of channels exists, an agent (e.g., a channel selection agent or mechanism) on the device and said network-based clients/device side components may provide the means to negotiate a channel. Different channels may also exist between device side 320 and network side 310. Similarly, if a choice of channels exists, components on device side 320 and components on network side 310 may provide the means to negotiate a channel. The simple HTTP interface is an example of a channel.

Device side 320 includes an Address Book (e.g., CAB) client 322, a Data Synchronization (DS) client 324 and an XML Document Management client (XDMC) 326. As shown, the address book client 322 may communicate with the address book server 340 via DS client 324 and the OMA_DS interface. Additionally, the address book client 322 may communicate with the address book server 340 through XDM enabler 344 acting as proxy for the server 340. In this case, the client 322 may communicate with the server 340 via XDMC 326 and XDMS 346 through one or more of interfaces XDM-1, XDM-3, XDM-5 and XDM-7.

With reference to FIG. 3, the functionality of searching contact sources may be provided by the XDM Enabler 344. XDM Enabler 344 provides an interface XDM-5 that is based on Limited XQuery to search for XML documents stored in or accessible by XDMS 346. XQuery, which is defined by W3C, is a standard mechanism to search across XML documents.

Specifically, the interfaces XDM-5 and XDM-7 are used to perform the Contact Search function, wherein the client request is carried over XDM-5 to the XDM Enabler 344 and wherein XDM-7 is used by the XDM Enabler 344 to communicate with the interworking functional module 342 for searching across external directories or sources. The results from the internal (e.g., CAB XDMS 346) and external sources/directories (e.g., using the interworking functional module 342) are aggregated at the search proxy in the XDM enabler 344.

Although the foregoing-described systems and methods are useful for searching information stored in internal data stores (e.g., CAB XDMS), they do not provide a way to address search requests towards external directories (e.g., a third party network directory such as Yellow Pages™, 411 directory assistance, etc.) and manage data from those external directories (i.e., provided that the external directories are operable to recognize a search request from the address book system).

XQuery is a powerful solution for searching across XML documents. However, in order for XQuery to work well in, for example, the context of querying multiple contact information sources, the XQuery requestor (e.g., the client or any other entity such as a web service) should be aware of the data format used by the destination source. Furthermore, the XQuery requestor should be aware if the data returned from the source can be expressed in XML. In some instances it may not be efficient or it may be difficult to require that the data from the destination source(s) can be expressed in XML for the purposes of XQuery.

Herein, a method is provided for searching multiple resources (e.g., including a CAB server which has general public information per CAB user as well as private information per “friend” of the search user, and external directories provided by the service providers) for contact information or contact entries. In one case a “friend” can make different contact details available to requestors that have properties in common (e.g., member of an exclusive club). In yet another case a “friend” can make different contact details available to requestors based on the requestor's credentials. Still further, a “friend” may made different contact details available compared to contact details previously made available in the past. The right to access contact details may be stored or the actual contact details themselves have been stored or a friend enables access to different contact details using another mechanism. In one embodiment of the present system and method a standard XML document to which other resources must adhere is employed. In another embodiment, HTTP-based interfaces targeted at the standard XML document are employed. In yet another embodiment the present system and method maintains copies of select public information as well as pointers or URIs towards the source. The information selected for maintaining locally may be based on heuristics. These copies of select public information may be regularly updated. The mapping of keywords used in search strings or XQuery-based search request offered over, for example, an HTTP interface to address data can be heuristic based wherein the heuristics may be maintained per user in such a way that search operations become more efficient or in such a way that if multiple languages are mixed in the search string, results are still desirable from a user's perspective. In some embodiments, results may be sorted and/or filtered based on some characteristics. For example, addresses can be sorted based on properties such as distance to the location of the user. In another example, the address information of friends can be promoted to the most visible spot in a list (e.g., top of a list) with addresses. Address entries of a user with multiple phone numbers can be placed such that “in network” address entries are promoted more than other, less desirable contact alternatives.

Although OMA CAB documentation specifies four functionalities, the present disclosure is provided for focusing primarily on the Contact Search functionality. In particular, the present disclosure provides a system and method for supporting searching of external directories (e.g., Yellow Pages™, 411 directory assistance, etc.). Searching external directories may be performed based on standard XQuery request and/or a keyword string mechanism by defining a standard address book search format to address the search toward the external directories. While the illustrated and described examples herein are provided with regard to Internet protocol (IP) based protocols (e.g., HTTP), the present disclosure is not meant to be limited as such. Indeed, in other embodiments a protocol such as SIP or proprietary protocols could instead be used. Furthermore, while the illustrated and described examples herein are provided with regard to extensible markup language (XML), the present disclosure in not meant to be limited as such. Indeed, other languages may be employed such as generalized markup language (GML), hypertext markup language (HTML), extensible hypertext markup language (XHTML), etc.

When XML is used, an associated MIME type and XML schema will also be defined for transporting XML documents or fragments over transport protocols such as HTTP. One such protocol method for requests is HTTP POST.

The address book enabler (e.g., the CAB architecture as specified by OMA) provides a mechanism to search for contact information. It aims to provide the common address book users to search for the contact information from within the host common address book system, remote common address book system and/or external databases made available by a service provider such as, for example, Yellow Pages™. The contact information made available for search operations is subject to a common address book user's authorization rules and a service provider's policies.

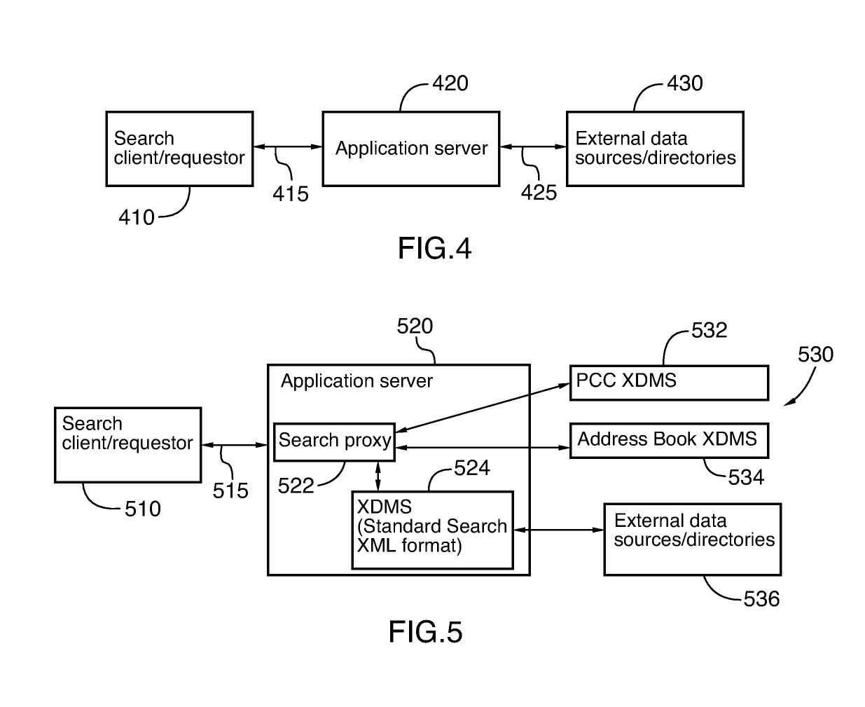

Referring now to FIG. 4 an example search method is described with respect to a high-level system/architecture diagram. As shown in FIG. 4, the search client/requestor 410 (e.g., client 122 shown in FIG. 1) makes a request to the application server 420 via an interface 415. The application server 420 may be, for example, address book server 140 shown in FIG. 1 or the XDM enabler 344 shown in FIG. 3 which is configured as a proxy to the address book server 340. The search request may include an Xquery and/or a keyword string expression based on a standard XML search data format defined by the application server 420 (e.g., hosted by the interworking function or a contact search function within the application server). In an alternate implementation, which will be described hereinafter with reference to FIG. 5, the standard format may be also hosted by a search proxy that may act as the central point for all search requests and aggregation of search results which are then sent back to the client.

The standard XML format of the application server 420 may be compatible with data sources 430 that are employed by or otherwise accessible to the application server 420. Data sources/directories 430 may include one or more of the following: PCC XDMS; Address book XDMS; and external data sources. The standard XML format may minimize the data conversion procedures between the native format of the data sources and the standard search format, thereby facilitating substantially lossless data conversion. The application server may be embodied or configured at least partially as or on an address book server and/or an XDM enabler. The interface 425 shown in FIG. 4 defines or otherwise facilitates the interactions between the application server 420 (e.g., interworking function, or contact search function, or a search proxy in the XDM enabler) and the data sources/directories 430.

The interaction between the external directories included in the data sources/directories 430 and the application server 420 may be based on the public interfaces or APIs supported by the entities (e.g., service providers) hosting the external directories. Data from the external sources is converted to the standard XML search format defined in the application server in order to make the data accessible to the Xquery from the search requestor. In one instance, the data from the external sources may be pre-formatted or converted (e.g., in a non-real time fashion) to the standard search format prior to the search request. In yet another instance, formatting or converting of the data from the external sources may be performed in real (or near-real) time by defining one or more mappings between the native data format of the external directories and the standard search format. In such case, the original Xquery request (i.e., from the search client/requestor 410 to the application server 420) may need to be translated to an external directory-specific query in real (or near-real) time based on the mappings. In certain implementations, the real or near-real time formatting or converting of data may be more efficient since it offers more flexibility for third party search providers that operate and/or maintain the external directories. For example, instead of converting all data from an external directory it may be sufficient to provide a mapping between the standard XML format and a native format used by an external directory.

Turning now to FIG. 5, another example search method is described. As shown in FIG. 5, the search client/requestor 510 (e.g., client 122 shown in FIG. 1) makes a request to the application server 520 (e.g. address book server 140 shown in FIG. 1) via an interface 515. The search request may include an Xquery and/or a keyword string expression based on a standard XML search data format defined or otherwise employed by the application server 520. As shown in FIG. 5, the application server 520 includes a search proxy 522 and an XDMS 524 which hosts and is operable to apply the standard search XML format. The XDMS 524 may be similar to or different from the previously-mentioned CAB XDMS 346 (FIG. 3). The XDMS 524 may apply the standard search XML format in a bi-directional manner. That is, the XDMS 524 may: 1) map a received Xquery (from the search client/requestor 510) to an outbound external source-specific query; and 2) map results received from the external source to the standard format so it can be searched against and/or reported back to the client 510. The XDMS 524 may be a logical function. Additionally, the XDMS 524 may be an independent component or hosted by the Interworking functional module (e.g., block 260 of FIG. 2 or block 342 of FIG. 3) or the contact search function (e.g., block 250 of FIG. 2) within the application server. The search proxy 522 may be configured as a central point for search requests and aggregation of search results which are then sent back to the client.

When the search request is received by the application server 520, the search proxy 522 may relay the request directly to compatible data sources 530 that are internal, trusted or otherwise known to properly interpret and respond to the search request without needing to perform reformatting or conversions. As shown, the compatible data sources 530 may include the PCC XDMS 532 and the Address Book XDMS 534, however other contact information/data sources may be provided. In cases when the search request includes a query of an external or third-party data source/directory 536 that is “incompatible” (i.e., a data or contact information source that is not configured to accept, interpret and/or respond to XML-format requests or otherwise return XML-format data), the search proxy 522 may cooperate with an XDMS 524 (e.g. hosted by the Interworking function) to communicate with the data source/directory 536.

The XDMS 524 may perform data conversion procedures between the native format of the external or third-party data sources 536 and the standard XML search format, thereby facilitating substantially lossless data conversion. This process of conversion may be performed by a conversion function within the application server (e.g., block 420 of FIG. 4 or block 520 of FIG. 5). Furthermore, the conversion may be done by the Interworking Function, Contact Search Function or both within the address book server which may utilize the interfaces or APIs provided by external search data systems hosting the external directories. After performing data conversion or reformatting of data received from the external sources 536, the XDMS 524 may communicate converted/reformatted data to the search proxy 522 which then may aggregate the data from various contact information sources (e.g., sources 532, 534, 536 as shown). After the conversion or reformatting and, optionally performing the aggregation, the search proxy 522 may report the results of the search request/query to the client 510.

In order for an address book client to perform a contact search of the address book server as well as other contact information sources, a request is communicated from the device side to the network side. Various requests would be known to those in the art, and two examples include a simple keyword search and a complex XQuery search.

A simple keyword search model allows the address book user to query a network address book by utilizing simple keywords. A typical search request format is:

<ContactSearch>

<----------------------data for search request or response goes here

</ContactSearch>

An example search request using simple keyword(s) is:

<ContactSearch>

<Request>

<Keyword maxResults=”50”>example </Keyword>
<dataSource>yellowpages.com</dataSource>

</Request>

</ContactSearch>

An example search request in XML format based on XQuery is:

<ContactSearch>

<Request>

<XQuery maxResults=”50”>

<------XQuery URI in CDATA format for search request
goes here

</XQuery>
<dataSource>yellowpages.com</dataSource>

</Request>

</ContactSearch>

In the above examples, <Contact Search> is the root node of the search document which is common to both the search request from the client to the server and the search response back from the server to the client. A <ContactSearch> element can contain either a <Request> or a <Response> element.

<Request> is a container element which contains the search request data in XML. The Request element can contain either the <Keyword> element or the <XQuery> element.

<Keyword> is the element that carries the actual search data. In other words, the keyword to search elements from the network address book system is described by this parameter. The data type of this element is a “String.” This element may contain an attribute ‘caseSensitive’ which indicates whether the search should be conducted in a case-sensitive manner or note. The type is a boolean with the following enumerands {“true”, “false”}. In one embodiment the default value is “false”. Additionally, this element may include an attribute “maxResults” which defines the maximum number of results that can be returned and is of type integer. If no such attribute is specified, a default value may be used. In the example above, the maximum result is defined as 50 indicating that at most fifty results can be returned at which point the search cuts off, discards or ignores the remaining response.

<XQuery> is the element that carries the search request data that is conforming to W3C XQuery. This element is used to query the network-based address book system for complex queries with specific criteria. This element contains an attribute ‘maxResults’ which indicates the max number of results that should be returned for the XQuery search. Alternatively, there can be a default value for this attribute (e.g., 10 results). The type is an ‘Integer.’

In case at least one of a local address book storage or another (e.g., corporate or enterprise) address book storage is also searched and matches are found, the matches may be integrated in the results received as part of the XQuery search request's response (or other channel's search request response). If maxresults or the maximum number of results to be presented to the searching user or component (her forwards, the maximum number of results to be presented to the searching user or component is also known as maxresults) is set to a value, and the sum of the number of local matches and the number of the matches returned as XQuery search request's response (or other channel's search request response) is higher than the maxresults, special consideration of how to handle the voluminous results may be needed. Either the total number of matches is presented or no more than the value of maxresults. If no more than the value of maxresults is presented, either the XQuery or other channel's search request may indicate the initial maximum number or results expected in a first response. Subsequent XQuery search request responses may contain maxresults number of results. In another embodiment, the device side components integrate search results and take of presenting only maxresults matches.

The <dataSource> is an element that indicates or otherwise defines the (internal and/or external) data source(s) to which the search request should be applied. Accordingly, the dataSource element is one feature for enabling searching of multiple contact information sources and aggregating the (at least partially) matching data therefrom. The data Source element may designate or define one or more data sources (e.g., multiple XDMSs, AUIDs or multiple external directories) for the contact information searching operation. The dataSource element may indicate a data source that should be included in the search. Alternatively, a text string following the dataSource element can also represent data source(s) are to be excluded from the search.

The word “example” in the keyword search above indicates the keyword that is being searched. Thus, for example, if the user was searching for all contacts within Dallas (or with a link or reference to Dallas) then the keyword search could be based on the word “Dallas”. To this end a list of results vis-a-vis Dallas could be returned to the address book client.

As a result of the search request, a response is received at the client from the application server. The result or the response from the application server would yield a list or other data structure of possible results. An example response is:

<ContactSearch>

<Response>

<Result userId=”x@example.com”>X</Result>

<dataSource>yellowpages.com</dataSource>

<Result userId=”y@example.com”>Y</Result>

<dataSource>PCC XDMS</dataSource>

</Response>

</ContactSearch>

Where <Response> is a container element which contains the results from the search request from the server back to the client. The response element can contain one or more <Result> elements.

<Result> is an element that contains a single result based on the search request. For multiple results, a sequence of Result elements is generated by the server. This element contains the “userId” attribute, which indicates a unique identifier for the contact in the result. The result can further include a <dataSource> element.

<dataSource> is an element that indicates the data source from which the search result is returned. The data source information can be used to allow the user navigate into the external search provider's domain for further interactions.

In some instances the server may be configured to order the Result elements in the response. For example, contact information (e.g., addresses) of people that also match some additional property or properties may be presented earlier in the response compared with contact information of people that do not match the additional property or properties. For example, people/resources that have the same home town or in the same area or adjacent postal code of the home town, people/resources that are found in the searching user's address book as opposed to people/resources with the same name found in public address books may receive a different or preferred entry position in the list (e.g., higher versus lower, or vice versa) of matches.

Since a limited number of Result elements may returned (e.g., according to a default or a specified maxResults element) some ordering/filtering may be performed by, for example, the client or alternatively the element in the network (e.g., the application server) that performs the search. The filtering can employ default values such as home town, other shared properties. However, the search request could also include some values for the filter. Furthermore, user profile/preferences which may be stored in, for example, a portion of the address book server such as user account/profile 210 (FIG. 2) or a portion of the XDM enabler (e.g., block 144 of FIG. 1) such as a User Preferences XDMS, can utilized for ordering/filtering returned search data. Additionally, priority of such filter values can be set. Default settings for the user profile/priorities can be different per user and can be determined by heuristics (e.g., based on passed search requests).

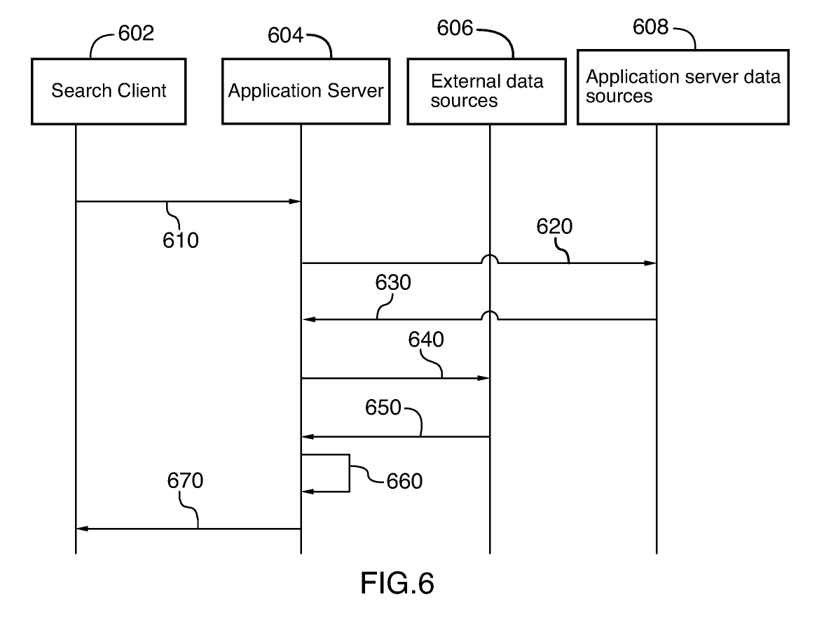

Referring now to FIG. 6, an example messaging diagram is provided for describing an example method for searching multiple contact information sources (e.g., sources 606 and 608 as shown). In FIG. 6 the search client 602 (which may be similar to or different from clients 122, 322, 410 and 510) may already be authenticated and authorized against the corresponding application server 604 (e.g., address book server which may be similar to servers 140, 340 (in cooperation with XDM enabler 344), 420 and 520). Furthermore, the XDMS (which may be included in application server 604 similar to application server 520) may already be authenticated and authorized against the corresponding address book server.

As shown by arrow 610 in FIG. 6, the client 602 communicates a search Request for contact information or contact entries to the application server 604. As can be appreciated, in some instances the search Request communication or message indicated by arrow 610 may be communicated directly to the address book server as per the example architecture illustrated in FIG. 1. However, in other instances the search Request communication or message indicated by arrow 610 may be communicated indirectly to the address book server. That is, the search Request communication or message may be directed to the XDMS (acting as a proxy for the address book server) as per the example architecture illustrated in FIG. 3 after which the XDMS may communicate or relay the search Request communication or message to the address book server. Regardless of which entity receives the search Request, responsive to receiving the search Request, the application server 604 may substantially simultaneously communicate search requests indicated by arrows 620 and 640 to application server data sources 608 (e.g., PCC XDMS, Address Book XDMS) and external data sources 606, respectively. Based on the communicated search Requests 620, 640, the application server 604 receives search responses 630 and 650. Response 630 being returned to the application server 604 from the application server data sources 608, whereas response 650 is returned to the application server 604 from the external data sources 606. As can be appreciated, receipt of response 650 may involve real-time or near real-time data conversion when the external data sources 606 do not provide data in a standard or expected XML format. As shown by communication arrow 660, the application server may aggregate search responses from the various sources 606 and 608 for composing a response in which the search results may be combined. As shown by communication arrow 670, the application server 604 communicates (e.g., via interface 415 of FIG. 4 or interface 515 of FIG. 5) the response that includes search results to the client 602. As can be appreciated, ordering/filtering of results from the various sources may be performed before, after or during the aggregating of results indicated by arrow 660.

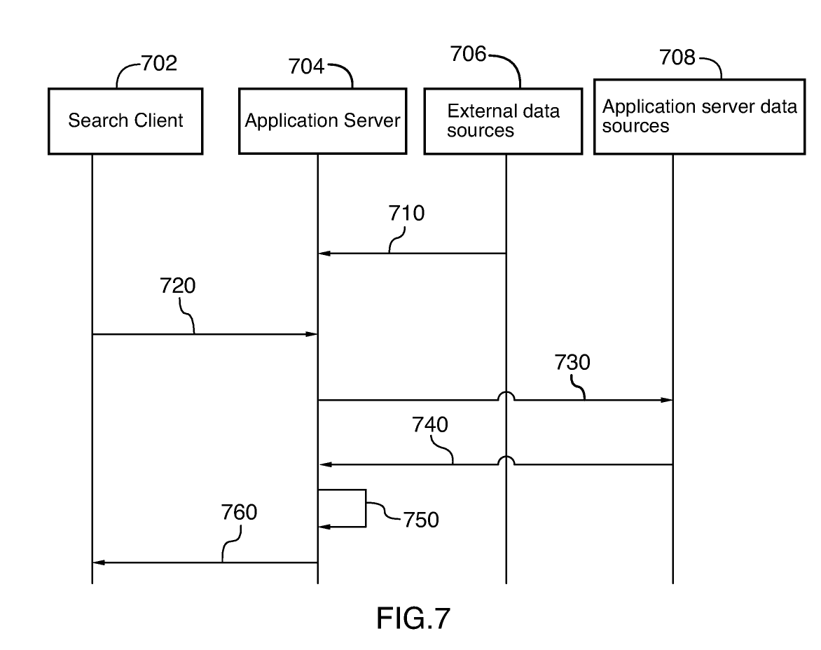

Referring now to FIG. 7, another messaging diagram is provided for describing another example method for searching multiple contact information sources. In the diagram of FIG. 7 it should be appreciated that the search request to external data sources is performed in non-real time. That is the data from the external data sources/directories 706 is received by the application server 704, converted, mapped to a standard format, or otherwise processed and stored in advance of a search request from the client 702. In this way response latency, which may occur due to the data reformatting/conversion of data from external contact information/data sources, is prevented or substantially minimized.

As shown by arrow 710 in FIG. 7, data in a non-standard or unexpected (e.g., non-XML) format is received by the application server 704 from the external data sources 706 in advance of the application server 704 receiving a search request from the client 702. By receiving data from the external data sources 706 in advance of the search request, the application server 704 may convert the data to the standard or expected XML search format that conforms to the format/type also used by the application server data sources 708 (e.g., PCC XDMS, Address Book XDMS, etc.) in order to make data from the various sources easily and quickly accessible to the Xquery from the search client 702 or requestor. As previously mentioned, the data may be converted using mappings between the native data format of the external directories and the standard search format. An example standard search format in XML that may be employed is:

<?xml version=“1.0”?>
<contact>

<firstName>Joe</firstName>
<lastName>Smith</lastName>
<prefix>Mr.</prefix>
<Address> 0000 example street, example city...</address>
<URL>www.example.com</URL>
<tel>111-111-1111</tel>
<geo-location> GPS/wireless cell coordinates </geo-location>
<displayName> Mr. Nice</displayName>
<displayImage>Image URL</displayImage>
<organization> company X</organization>

</contact>

Although the foregoing XML relates to basic or typical contact information/properties that can be included in a standard search format, other XML standard search formats may include additional contact information/properties. For example, the standard search format may be or employ the same XML format or a subset of the XML format used by the PCC or a contact entry of the address book contact entry. Employing a standard format in the application server will allow the client to perform an Xquery request from the client towards such format and will also allow external or third-party contact information/data providers (e.g., Yellow Pages™, etc.) to convert their native data to a standard format, thereby making their data more readily accessible, searchable and usable in response to clients' search requests.

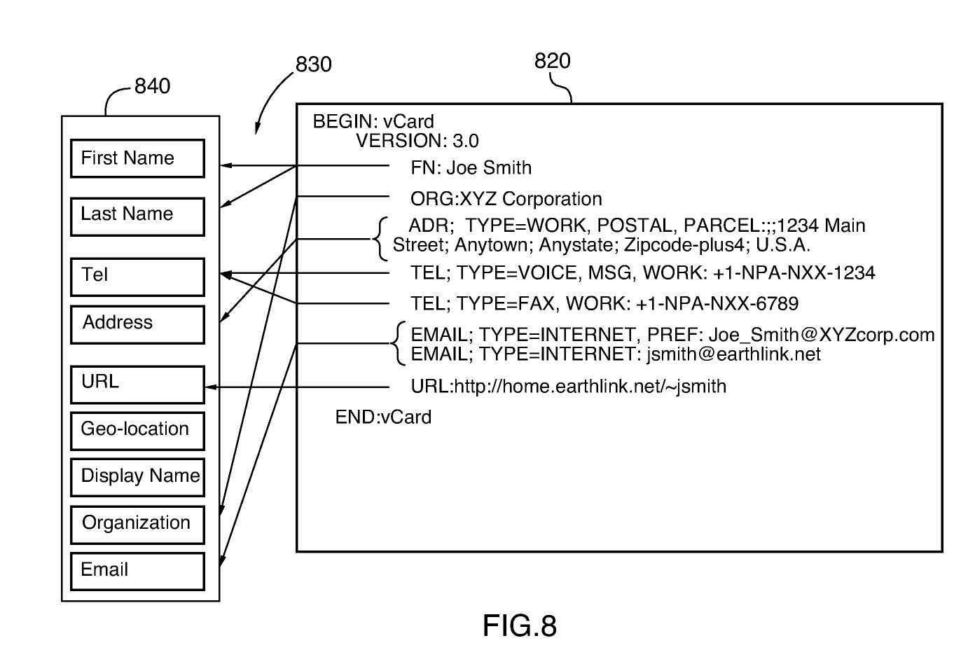

Referring now to FIG. 8, an example data conversion/mapping is illustrated between a first data structure format which is output by an external data source and a second data structure format (which may be stored in advance of a search request and searched against). As shown in FIG. 8, an external data source is configured to provide contact data or information in a first data structure 820 (e.g., vCard format or the like). The first data structure 820 includes: contact name; organization; address; telephone numbers (voice and fax); email addresses (work and personal); and website (e.g., URL). However, external data sources may provide data structures with different data or differently-ordered/configured data. For example, the first data structure from another external data source may include fewer or additional information fields. As further shown, the second data structure 840 includes: first name; last name; telephone number; address; website (URL); geo-location; display name; organization; and email address. The second data structure 840 may be the foregoing-mentioned example standard search format in XML.

As shown in FIG. 8, a mapping 830 may identify information fields (e.g., by keywords or data format) in the first data structure 820 and populate fields of a second data structure 840 with the information of the first data structure 820. For example, as shown in FIG. 8, the first name and last name fields of second data structure 840 are populated using the mapping 830, which may parse the first and last names from the name field of the first data structure 820. Other fields of the second data structure 840 may be populated using similar or different techniques.

Turning again to FIG. 7, as indicated by arrow 720 the client 702 communicates a search Request for contact information or contact entries to the application server 704. As can be appreciated, in some instances the search Request communication or message indicated by arrow 720 may be communicated directly to the address book server as per the example architecture illustrated in FIG. 1. However, in other instances the search Request communication or message indicated by arrow 720 may be communicated indirectly to the address book server. That is, the search Request communication or message may be directed to the XDMS (acting as a proxy for the address book server) as per the example architecture illustrated in FIG. 3 after which the XDMS may communicate or relay the search Request communication or message to the address book server. Regardless of which entity receives the search Request, responsive to receiving the search Request, the application server 704 may communicate a search request indicated by arrow 730 to application server data sources 708 (e.g., PCC XDMS, Address Book XDMS). Based on the communicated search Request 730, the application server 704 receives a search response 740 from the application server data sources 708. As shown by communication arrow 750, the application server 750 may aggregate search responses from the various sources 706 and 708 for composing a response in which the search results from sources 706, 708 may be combined. As shown by communication arrow 760, the application server communicates (e.g., via interface 415 of FIG. 4 or interface 515 of FIG. 5) the response that includes search results to the client 702. As can be appreciated, ordering/filtering of results from the various sources may be performed before, after or during the aggregating of results indicated by arrow 750.

Various embodiments are described herein. However, these embodiments are non-restrictive and provided for illustrative purposes. As such, it should be appreciated that the present disclosure is intended to cover all modifications and equivalents of the subject matter recited in the claims unless otherwise indicated herein or otherwise clearly contradicted by context.

What is claimed is:

1. A method, performed by a server of an address book architecture, of searching for contact information, the method comprising:
receiving, from a client or proxy associated with the server, a contact search request specifying a directory to be searched for contact information, the directory being external from the address book architecture; and
translating the contact search request into an external search request, the external search request being in a format supported by the external directory.

2. The method of claim 1 wherein the contact search request includes an XML element <dataSource> for identifying the directory to be searched for contact information.

3. The method of claim 1 further comprising:
sending, after the translating, the external search request to the external directory;
receiving a response, the response including a result that is relevant to the external search request; and
communicating the result to the client or the proxy.

4. The method of claim 3 wherein the response further includes an XML element <dataSource> for identifying a directory associated with the result.

5. The method of claim 1 wherein the search request specifies a first external directory and a second external directory which are to be searched for contact information, and wherein the translating comprises:
translating the contact search request into a first external search request, the first external search request being in a first format supported by the first external directory;
translating the contact search request into a second external search request, the second external search request being in a second format supported by the second external directory; and
communicating the first and second external search requests to the first and second external directories.

6. The method of claim 5 further comprising:
receiving a first response from the first external directory, the first response including first results that are relevant to the first external search request;
receiving a second response from the second external directory, the second response including second results that are relevant to the second external search request; and
aggregating the first and second results.

7. The method of claim 6 further comprising one of ordering, sorting or filtering at least one of the first and second results according to a characteristic or property.

8. The method of claim 1 wherein the contact search request is in XQuery and based on a standard XML format.

9. The method of claim 8 wherein the standard XML format is hosted by an interworking function of the address book architecture.

10. The method of claim 8 wherein the standard XML format is one of:
a format of a personal contact card or a contact entry of an address book managed by the address book architecture; and
a subset of a format of a personal contact card or a contact entry of an address book managed by the address book architecture.

11. The method of claim 1 wherein the address book architecture, server, client and proxy are compliant with the Open Mobile Alliance (OMA) Converged Address Book (CAB) specification.

12. A method, performed by a client of an address book architecture, of searching for contact information, the method comprising:
creating a contact search request specifying a directory to be searched for contact information, the directory being external from the address book architecture; and
communicating the contact search request to a server or proxy associated with the client,
wherein the contact search request causes the server to translate the contact search request into an external search request, the external search request being in a format supported by the external directory.

13. The method of claim 12 wherein the contact search request includes an XML element <dataSource> for identifying the directory to be searched for contact information.

14. The method of claim 12 further comprising:
receiving a response from the server or the proxy, the response including a result that is relevant to the contact search request.

15. The method of claim 14 wherein the response further includes an XML element <dataSource> for identifying a directory associated with the result.

16. The method of claim 12 wherein the search request specifies a first external directory and a second external directory which are to be searched for contact information, and wherein the contact search request causes the server to:
translate the contact search request into a first external search request, the first external search request being in a first format supported by the first external directory;
translate the contact search request into a second external search request, the second external search request being in a second format supported by the second external directory; and
communicate the first and second external search requests to the first and second external directories.

17. The method of claim 16 wherein the contact search request further causes the server to:
receive a first response from the first external directory, the first response including first results that are relevant to the first external search request;
receive a second response from the second external directory, the second response including second results that are relevant to the second external search request; and
aggregate the first and second results for sending to the client.

18. The method of claim 17 wherein the contact search request further causes the server to order at least one of the first results, the second results and an aggregated list of the first and second results.

19. The method of claim 12 wherein the contact search request is in XQuery and based on a standard XML format.

20. The method of claim 19 wherein the standard XML format is hosted by an interworking function of the address book architecture.

21. The method of claim 19 wherein the standard XML format is one of:
a format of a personal contact card or a contact entry of an address book managed by the address book architecture; and
a subset of a format of a personal contact card or a contact entry of an address book managed by the address book architecture.

22. The method of claim 12 wherein the address book architecture, server, client and proxy are compliant with the Open Mobile Alliance (OMA) Converged Address Book (CAB) specification.

23. A method of searching for contact information, the method comprising:
adapting an interworking function, which is operable to import contact information from a first external directory to a converged address book storage, of an address book server to query a second external directory that does not support a standard XML format; and
using the interworking function to translate a contact search request, which is based on the standard XML format, from an address book client into an external search request that is in a format supported by the second external directory.

24. The method of claim 23 further comprising:
configuring the interworking function to aggregate results from multiple external directories.

25. The method of claim 23 wherein the contact search request includes an XML element <dataSource> for identifying the second directory to be searched for contact information.

26. The method of claim 23 wherein the contact search request is in XQuery.

27. The method of claim 23 wherein the standard XML format is one of:
a format of a personal contact card or a contact entry of an address book in the converged address book storage; and
a subset of a format of a personal contact card or a contact entry of an address book in the converged address book storage.

28. The method of claim 23 wherein the interworking function, converged address book storage, address book server and address book client are compliant with the Open Mobile Alliance (OMA) Converged Address Book (CAB) specification.

29. The method of claim 23 wherein the interworking function is configured to receive data from the second external directory and convert the data for searching relative to the contact search request.

30. The method of claim 29 wherein the interworking function is configured to convert the data from the second external directory: upon receipt of the contact search request; or before receipt of the contact search request.
